(19) United States
(12) Patent Application Publication
(10) Pub. No.: US 2013/0105492 A1
(43) Pub. Date: May 2, 2013

(54) MAGNETIC TABLEWARE

(71) Applicant: Ricardo Melgoza, Norton Shores, MI (US)

(72) Inventor: Ricardo Melgoza, Norton Shores, MI (US)

(21) Appl. No.: 13/660,194

(22) Filed: Oct. 25, 2012

Related U.S. Application Data
(60) Provisional application No. 61/553,548, filed on Oct. 31, 2011.

(51) Int. Cl. A47G 19/10; A47B 13/08; A47B 3/00; F16M 13/02

(52) U.S. Cl. 220/574; 108/28

(57) ABSTRACT

The present invention provides a tableware system wherein tableware items are operably coupled to magnets for magnetically coupling the tableware items to a table top or placemat, such that the tableware items stay in place on the placemat or table top due to magnetic attraction between the magnets of the tableware items and metallic members disposed in the table top or placemat.

### CROSS-REFERENCE TO RELATED APPLICATION

This application claims benefit under 35 USC §119(e) of provisional application Ser. No. 61/553,548, filed Oct. 31, 2011, entitled MAGNETIC TABLEWARE, the entire contents of which are incorporated herein by reference.

### BACKGROUND OF THE INVENTION

The present invention generally relates to magnetic tableware for use in outdoor settings, and, more particularly, to a magnetic tableware system.

When the weather permits, outdoor dining has long been an American tradition. While the weather may be warm and pleasant, the wind is often a factor in outdoor gatherings. Tableware items placed on a standard table, such as a picnic table, can often be caught in wind gusts and then be blown from the picnic table surface. For example, a plate generally has a lip which a wind gust can go under and then lift the plate off a table surface. This is often the case when the tableware items, such as plates, cups, bowls, and the like, are empty on a picnic or other outdoor table, such as when the picnic table is being set for outdoor dining. When high wind gusts are present, not only will empty tableware items be ejected from the table surface, but tableware items containing food or beverages can also be tipped over and carried off a table surface in such high wind gusts.

The present invention provides a tableware system wherein the tableware items are operably coupled to magnets for attaching the tableware items to a table or placemat, such that the tableware items stay in place on the placemat or table top, even in the presence of medium to high wind gusts. Thus, the present invention eliminates the difficulty of keeping tableware items on a table top for use in outdoor dining.

### SUMMARY OF THE INVENTION

One aspect of the present invention includes a tableware system comprising a placemat wherein the placemat is composed of a first layer and a second layer with a metallic member disposed therebetween. A tableware item having a bottom portion designed to abuttingly engage the placemat is configured with a magnet affixed thereto, such that the tableware item can be operably coupled to the placemat using magnetic power, wherein the magnetic power is sufficient to magnetically couple the tableware item to the placemat through either the first or second layer of the placemat.

Another aspect of the present invention includes a tableware system comprising a table having first and second leg assemblies disposed in a generally spaced-apart relationship. The first and second leg assemblies are configured to be abuttingly supported on a ground surface in a generally upright orientation. A top member is supported on and operably coupled to the first and second leg assemblies and the top member has at least one recessed area formed thereon. A metallic member is disposed in the recessed area of the top member. A tableware item having a bottom portion designed to abuttingly engage the top member of the table comprises a magnet affixed to the bottom portion of the tableware item, wherein the magnet provides sufficient magnetic power to magnetically couple the tableware item to the metallic member disposed in the recessed area of the top member.

Yet another aspect of the present invention includes a tableware system comprising a metallic placemat member having a first side, a second side and a periphery. At least one tableware item having a base portion is adapted to engage the placemat in a generally upright orientation. The table ware system further includes a magnet affixed to the base portion of the at least one tableware item having sufficient magnetic power to magnetically couple the tableware item to the metallic placemat member.

These and other features, objects and advantages of the present invention will be understood and appreciated by those skilled in the art upon studying the following specification, claims, and appended drawings.

### BRIEF DESCRIPTION OF THE DRAWINGS

FIG. 1 is a top plan view of a placemat assembly according to embodiments of the present invention;

FIG. 1A is a top plan view of a placemat assembly with a layer removed;

FIG. 2 is a perspective view of the placemat assembly of FIG. 1;

FIG. 2A is a fragmentary perspective view of the placemat assembly of FIG. 2;

FIG. 2B is a perspective view of the placemat assembly of FIG. 2 in a folded position;

FIG. 3 is a top plan view of a table assembly according to embodiments of the present invention;

FIG. 4 is a top plan view of a table assembly;

FIG. 5 is a top plan view of a table assembly;

FIG. 6 is a side elevational view of a table assembly according to another embodiment of the present invention;

FIG. 7 is a perspective view of a cup assembly according to embodiments of the present invention;

FIG. 7A is a cross-sectional view of the cup assembly of FIG. 7;

FIG. 8 is a cross-sectional view of a bowl assembly according to embodiments of the present invention;

FIG. 9 is a cross-sectional view of a plate assembly according to embodiments of the present invention;

FIG. 10 is a top plan view and partial fragmentary view of a tableware system according to embodiments of the present invention;

FIG. 11 is a side elevational view of the tableware system of FIG. 10;

FIG. 11A is a fragmentary side elevational view of a tableware system according to another embodiment of the present invention;

FIG. 12 is a fragmentary perspective view of a cup assembly;

FIG. 12A is a fragmentary perspective view of a cup assembly;

FIG. 12B is an exploded fragmentary perspective view of a cup assembly having a detachable base portion;

FIG. 13 is a fragmentary perspective view of a cup assembly;

FIG. 14 is a top plan view of a placemat assembly according to embodiments of the present invention;

FIG. 15 is a perspective view of the placemat assembly shown in FIG. 14;

FIG. 16 is cross-sectional view of the placemat assembly of FIG. 14.

### DETAILED DESCRIPTION OF THE PREFERRED EMBODIMENT

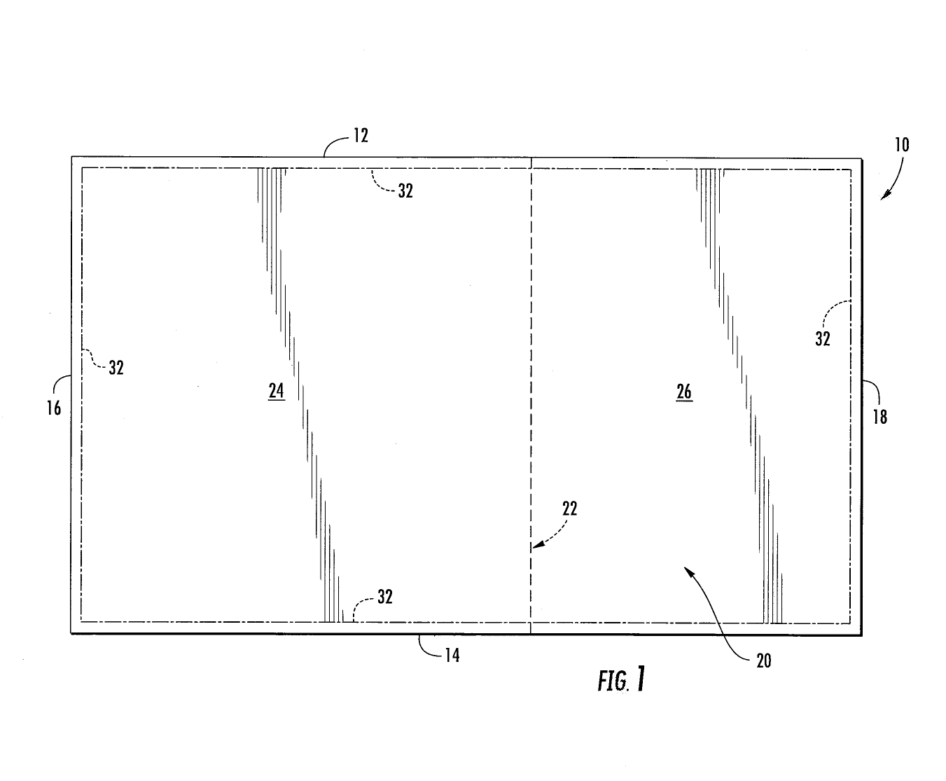

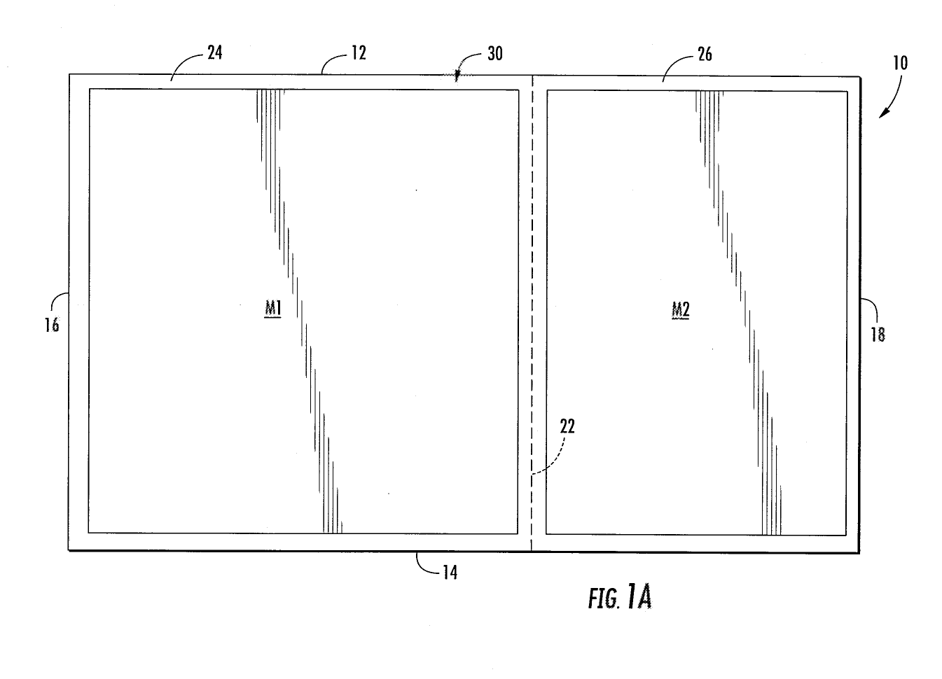

For the purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in following specification, are simply exemplary embodiments. Hence, specific dimensions and other physical characteristics relating to the embodiments disclosed herein are not to be construed as limiting, unless expressly stated otherwise.

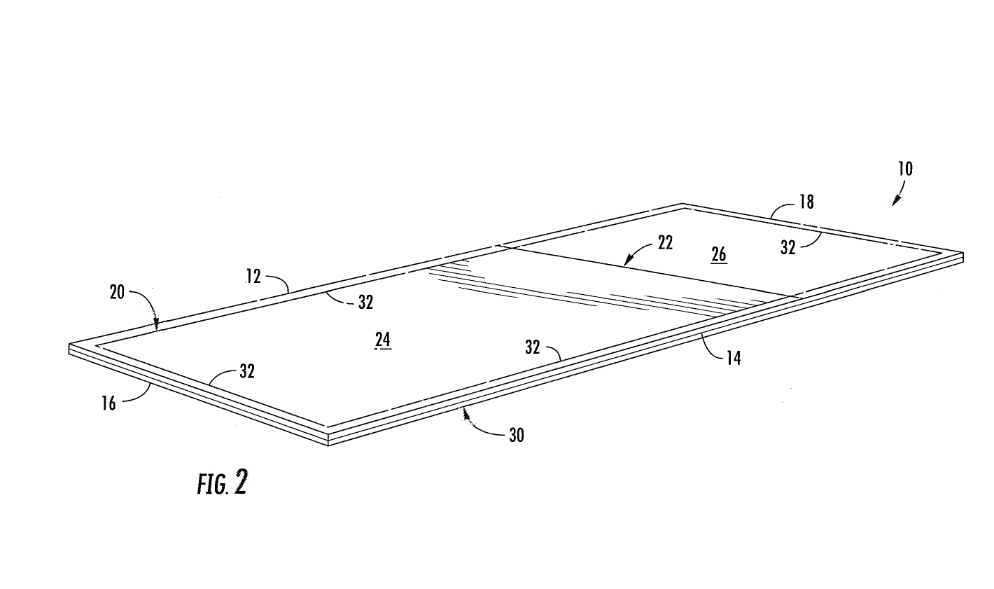

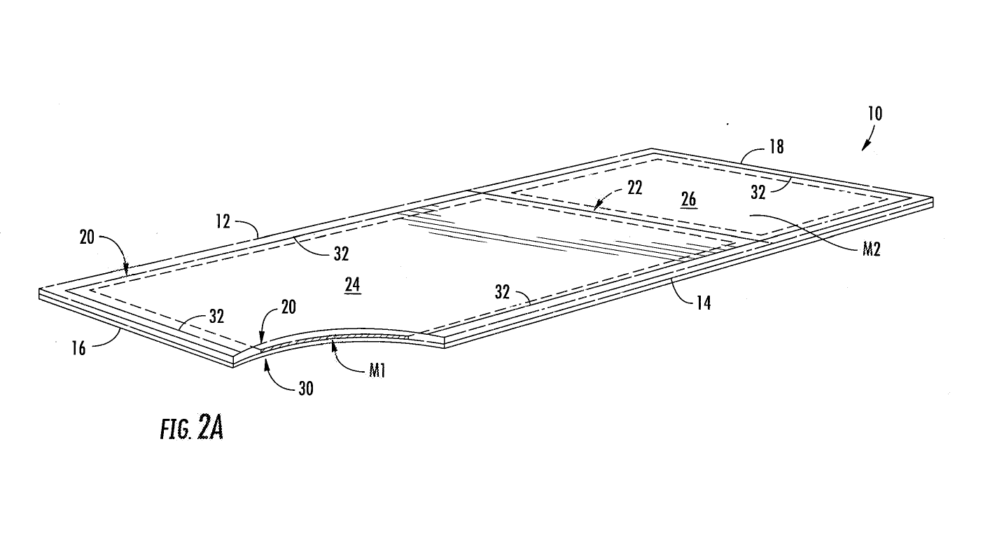

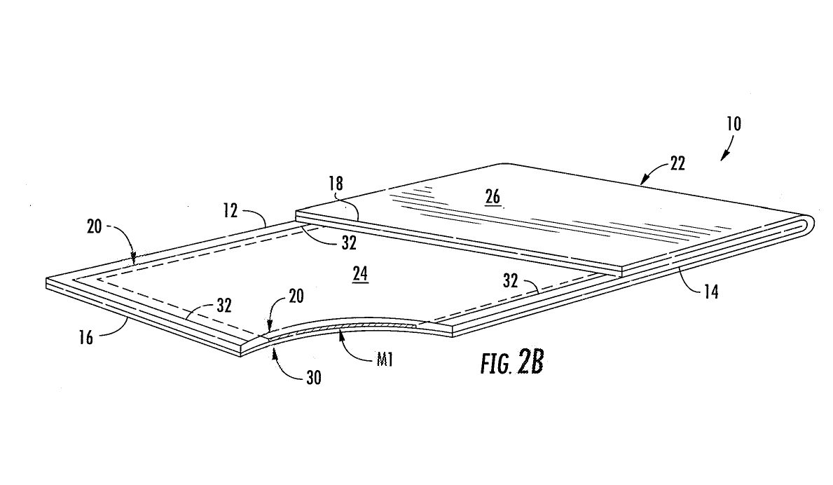

Referring to FIG. 1, the reference numeral 10 generally designates a placemat as used with the present invention. The placemat 10, as oriented in FIG. 1, has a top end 12, a bottom end 14, a left end 16, and a right end 18. The placemat 10 further comprises a first layer 20, which is divided into a first side 24 and a second side 26, with a living hinge or fold line 22 disposed therebetween. In this way, the placemat 10 is foldable along the fold line 22, such that the first side 24 or the second side 26 can be folded onto the other as shown in FIG. 2B. The first layer 20 is stitched to a second layer 30 (FIG. 2) as indicated by stitching lines 32 disposed around the top end 12, bottom end 14, left end 16, and right end 18 of the placemat 10.

Referring now to FIG. 1A, the placemat 10 is shown with the first layer 20 removed to reveal a second layer 30. The second layer 30 comprises a top end 12, bottom end 14, left end 16 and a right end 18 as also found in the first layer 20. The second layer 30 further comprises a fold line 22 and first side 24 and second side 26 disposed on either side of the fold line 22, as also found in the first layer 20. As shown in FIG. 1A, a metallic member or metal plate (M1) is disposed on the first side 24 of the second layer 30, and a second metal plate (M2) is disposed on the second side 26 of the second layer 30.

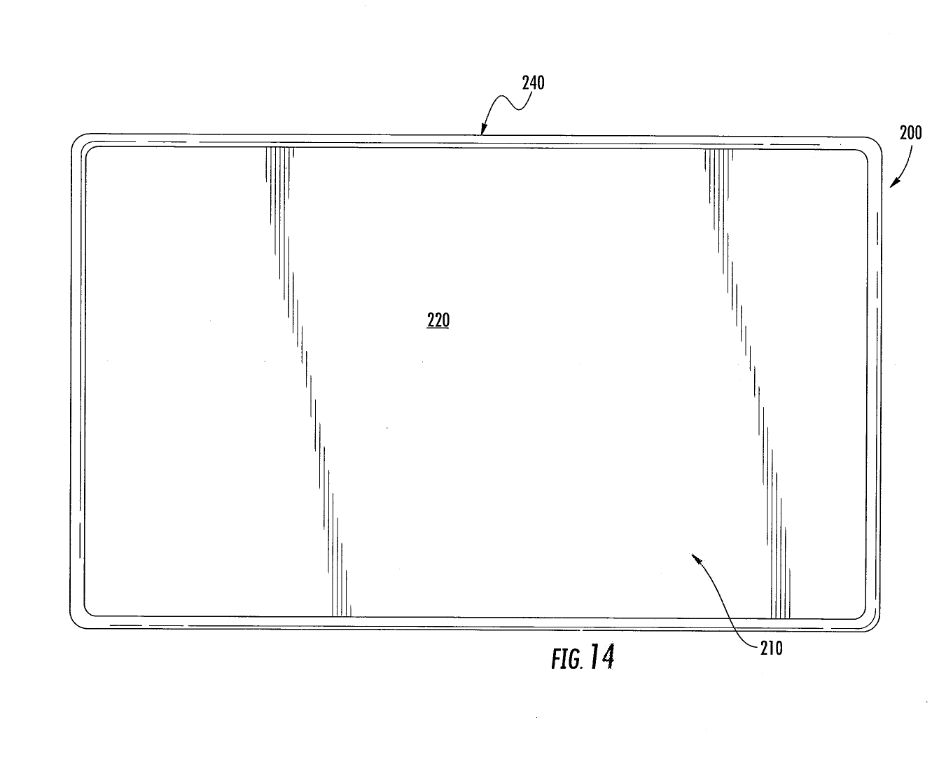

As shown in FIGS. 2 and 2A, the placemat 10, in assembly, has the first layer 20 disposed on top of the second layer 30 wherein the layers are stitched together along stitching lines 32. As shown in FIG. 2, the metal plates M1, M2 are concealed between the first layer 20 and the second layer 30, as indicated by the dotted lines on first and second sides 24, 26. As shown in FIG. 2A, the metal plates M1, M2 are sandwiched between the first layer 20 and second layer 30. The metallic members or metallic plates M1, M2 can be hot or cold rolled steel plates which are adhered to the first and second layers using an adhesive, such as a spray adhesive. The steel plates may be 0.0312 inches or 22.20 gauge steel. The first and second layers 20, 30 can be made from a water-resistant vinyl that is pliable to seamlessly conceal the metallic members M1, M2 disposed therebetween. The first and second layers 20, 30 can be stitched together with a UV thread along the stitching lines 32, thereby making the placemat 10 suitable for use outdoors. Further, the placemat can be a non-foldable unitary placemat having one or more metallic members disposed between layers. The layers can be joined by stitching, as noted above, or by other suitable means known in the art. Further, as shown in FIGS. 14-16, the placemat can be a unitary powdered coated steel plate as further described below.

In the embodiment shown in FIGS. 1-2A, the first side 24 of the placemat 10 is larger than the second side 26. This configuration allows for the placemat 10 to be dominant hand specific. For example, as tableware items are magnetically secured to the placemat 10, as further described below, a right-hand user may prefer to have plates and bowls on the larger side of the placemat with cups and flatware items on the smaller side. In this way, the placemat 10 can be rotated, such that the smaller second side 26 can be on the left-hand side or the right-hand side, depending on the dominant hand of the user. The first layer 20 and second layer 30 are also contemplated to have different colors on either side, such that the placemat 10 can be flipped to expose the layer with the color desired by the user.

As shown in FIG. 2B, second side 26 has been folded onto first side 24, such that the placemat assembly 10 is now a more compact version of itself making the placemat 10 better prepared for storage or travel. Again, as noted above, the placemat 10 shown in the embodiment of FIG. 2B has first and second sides 24, 26 wherein first side 24 is larger than second side 26. However, it is contemplated that the first and second sides 24, 26 can be of an equal size, such that when the second side 26 is folded on the first side 24, an even more compact version of the placemat assembly 10 is achieved.

Referring now to FIG. 3, a table 100 is shown having a top member or table top 110 which has a top end 112, a bottom end 114, a left end 116 and a right end 118. The table top 110 further comprises a first side 124 and a second side 126, separated by a spacing 122 at which the table 100 can be folded. The table top 110 of FIG. 3 is shown as a painted or powder-coated table top 110 which conceals recessed areas and metallic members as further described below.

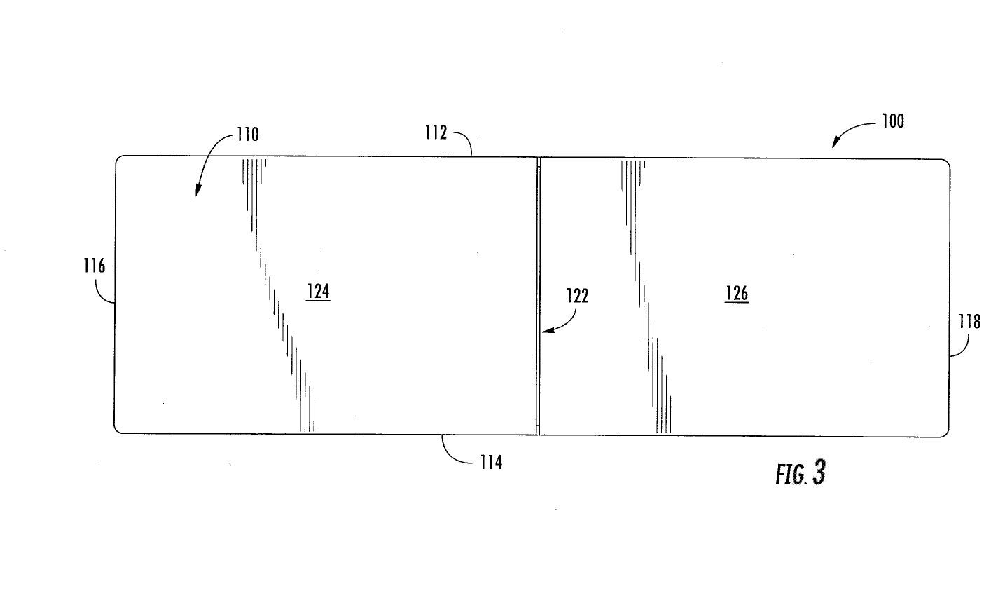

As shown in FIG. 4, the table top 110 of the table 100 has recessed areas 128, 130 disposed on the first side 124 and the second side 126, respectively. The recessed areas 128, 130 provide a small recession or inlay in the table top 110 for fitting a metallic member therein.

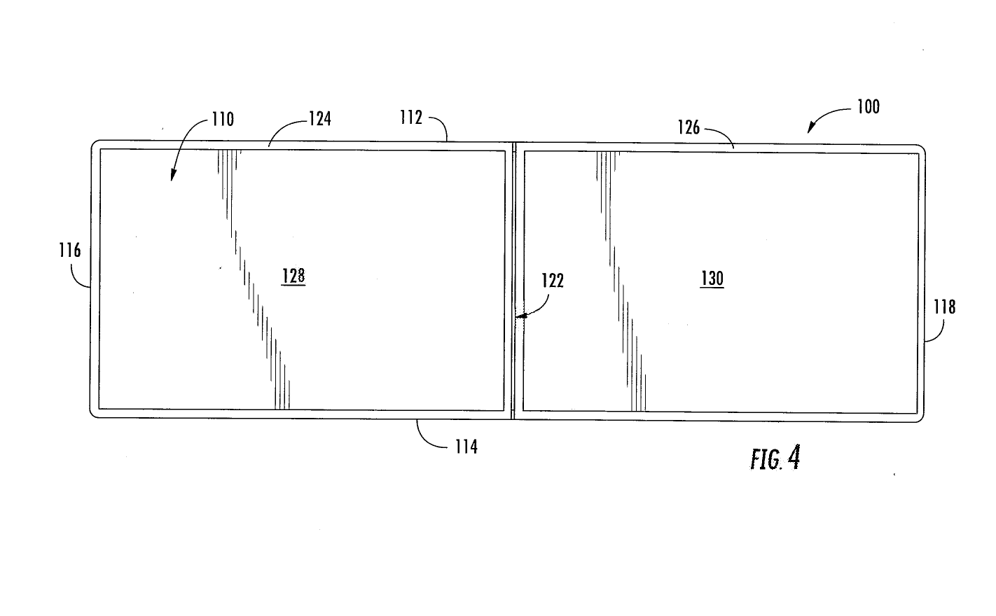

As shown in FIG. 5, metallic members M3 and M4 are shown disposed in the recessed areas 128, 130 of the first side 124 and second side 126, respectively. The recessed areas 128, 130 are configured such that the metallic members M3, M4 are substantially flush with the unrecessed portions of the first and second sides 124, 126. The metallic members can be hot or cold rolled steel plates that are approximately 0.0312 inches thick or 22.20 gauge steel, and the corresponding recessed areas 128, 130 can also have similar, but slightly larger, dimensions to fit the metallic members in such a way that they create a continuous top surface of the table top 110 which can be powder-coated or painted, as shown in FIG. 3, to conceal the metallic members M3, M4. The table can also be a non-folding unitary table with one or more recessed areas for housing a metallic member.

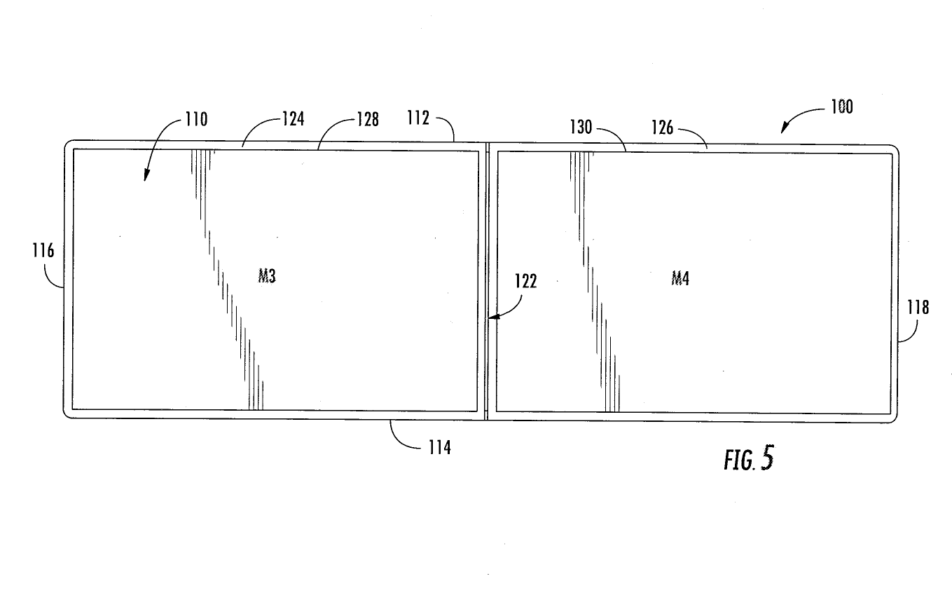

As shown in FIG. 6, the table 100 comprises first and second leg members 132, 134 disposed on the underside of first side 124 and second side 126, respectively. The leg members 132, 134 are foldable at hinge points 136, such that the leg members 132, 134 can be folded to the underside of the first and second sides 124, 126, along dotted lines A. Thus, the leg members 132, 134 are movable between a folded position and a deployed position. As shown in FIG. 6, the leg members are in the deployed position and are shown in a generally spaced-apart relationship relative to the table top 110 and are configured to abuttingly support the table top 110 on a ground surface in a generally upright orientation.

Table 100 is further foldable at the spacing 122, such that the first side 124 and second side 126 of the table top 110 can be rotate along the dotted line B to fold the table assembly 100. The table 100 of the present invention has foldable leg members 132, 134 and a foldable table top 110 which incorporates folding means known in the art.

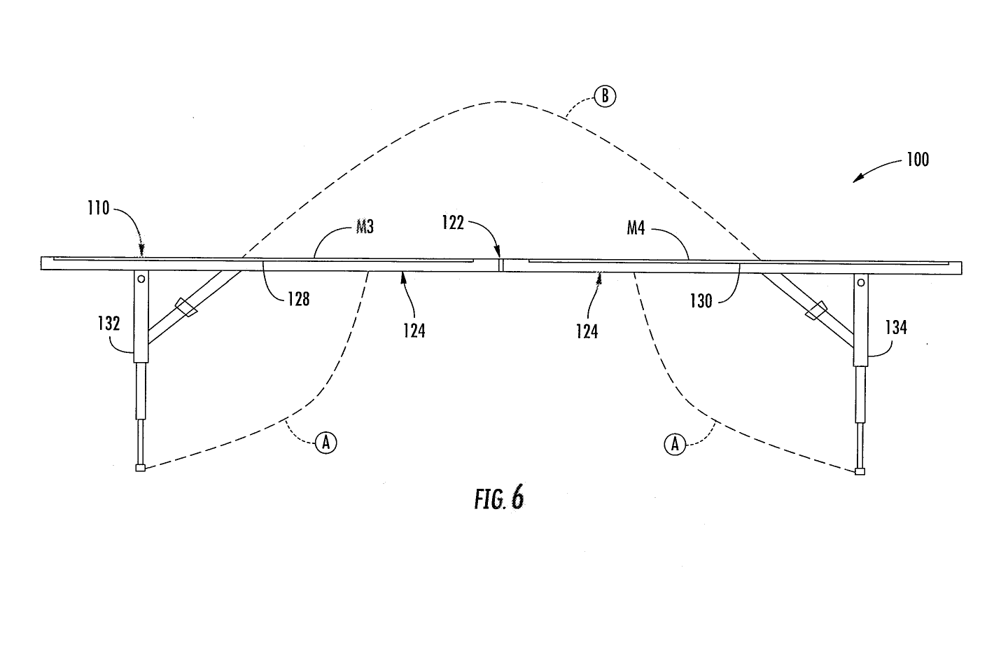

The table assembly 100 and the placemat 10 are for use in accordance with the present invention with one or more tableware items as will now be described. Tableware items to be used in conjunction with the placemat 10 or table assembly 100 will be exemplified in the form of a cup, plate and bowl as shown in FIGS. 7-12. However, it is contemplated that the present invention will work with other such tableware items not specifically exemplified.

As shown in FIGS. 7 and 7A, a tableware item is depicted in the form of a cup 40. The cup 40 has a rim 41 and a body portion 42 defining a cavity 43 for holding a liquid or other food item. The cup 40 further comprises a base portion 44 which, as shown in FIG. 7A, has a top portion 46 and a bottom portion 48 which are connected by a side wall 47. In this configuration, the base portion 44 of the cup assembly 40 has a recessed area 50 disposed between the top portion 46 and bottom portion 48. A side wall 47 connects the top portion and the bottom portion about the entirety of the base portion 44. As shown in FIG. 7A, the top portion 46 of the base portion 44 serves as the bottom wall of the cavity 43. The bottom portion 48 of the base portion 44 provides a rim or edge to abuttingly support the cup assembly 40 on a surface. On the bottom side of the top portion 36, a magnet M5 is shown disposed thereon. The magnet M5 can be adhered to the underside of top portion 46 of base portion 44 by an adhesive, such as a hot glue. The magnet is configured to be dimensionally complimentary of the recessed area 50 of base portion 44, such that a contacting surface 52 of the magnet M5 is substantially flush with the abutting surface of the bottom portion 48 of the base portion 44.

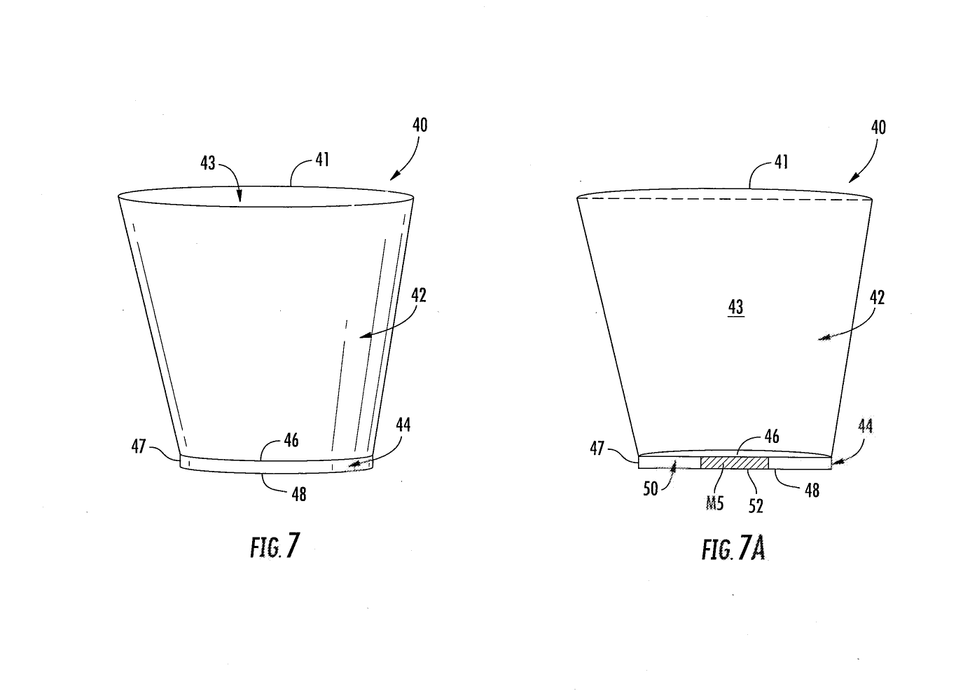

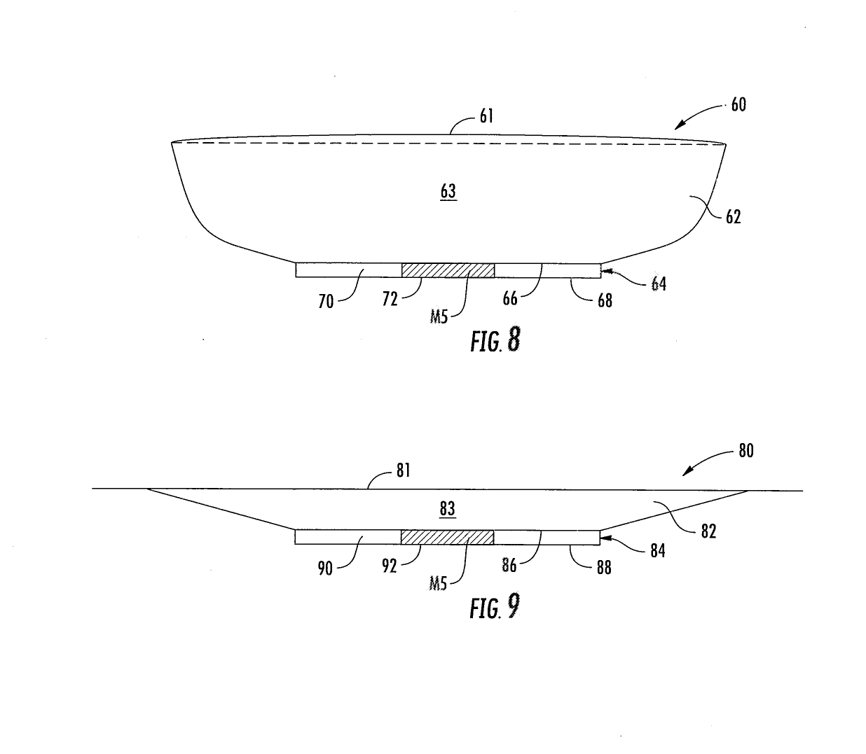

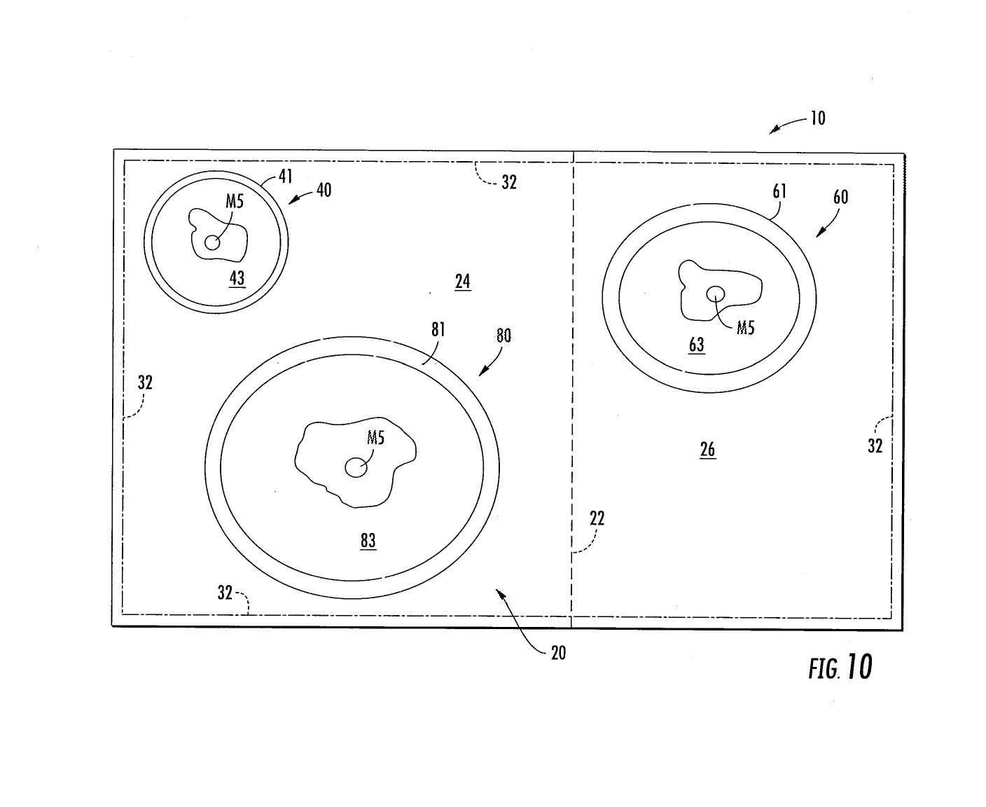

A similar configuration can be found in bowl 60, depicted in FIG. 8, and the plate 80, depicted in FIG. 9. Specifically, as shown in FIG. 8, a bowl 60 has a rim 61 and a body portion 62 defining a cavity 63 for holding a food item. The bowl 60 further comprises a base portion 64 having a top portion 66 and a bottom portion 68, which are spaced apart to define a recessed area 70. A magnet M5 is disposed on the underside of the top portion 46 of the base portion 64 and is dimensionally configured to compliment the recessed portion 70 of the base portion 64, such that a contacting edge 72 of the magnet M5 is substantially flush with the contacting surface of the bottom portion 68.

Similarly, the plate 80 shown in FIG. 9, has a rim portion 81 and a bottom portion 82 defining a cavity 83 for holding a food substance. The plate 80 further comprises a base portion 84 having a top portion 86 and a bottom portion 88, which are spaced apart to define a recessed area 90. A magnet M5 is disposed on the underside of the top portion 86 of the base portion 84 and is dimensionally configured such that a contacting surface 92 of the magnet M5 is substantially flush with the contacting surface of the bottom portion 88 of the base portion 84.

The magnets M5 are made to be flush with the contacting surface of the tableware item, such that the magnet will not cause the tableware item to rock or tip when magnetically coupled to the placemat 10 or table 100 of the present invention. Further, this flush configuration helps to protect brittle magnets from breakage when contacting a hard surface. The magnets M5 can have a varying strength for specific applications, however, it has been noted that one preferred embodiment for the magnets M5 would be a Neodymium magnet, which is particularly strong relative to the size of the magnet for adhering the tableware item to the placemat or table.

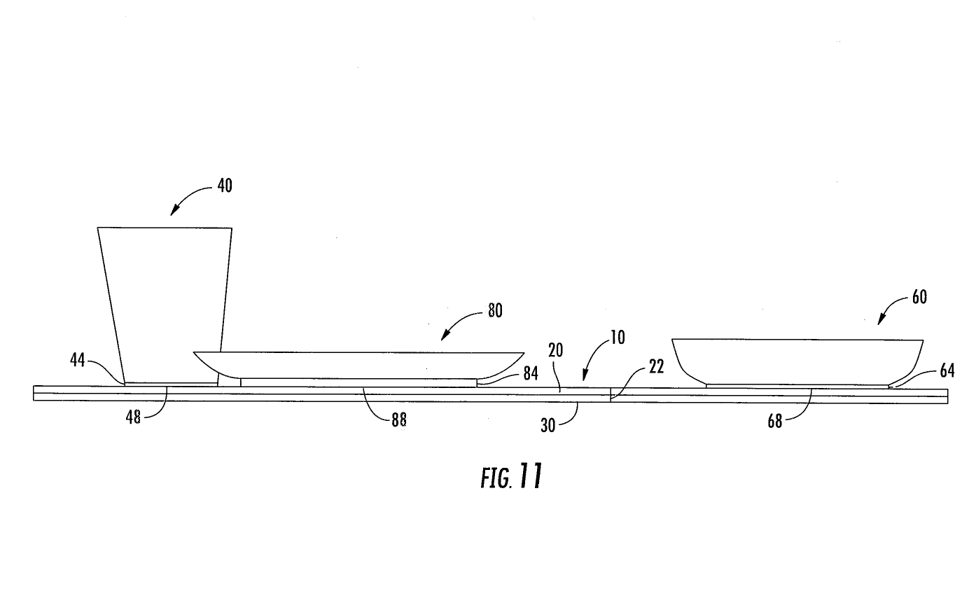

Referring to FIG. 10, a placemat 10, similar to the placemat depicted in FIGS. 1-2A, is shown with a cup 40, a bowl 60, and a plate 80 affixed thereto. The cup 40, bowl 60, and plate 80 are shown in FIG. 10 with cutaway portions of the top portion of the base portion of the tableware item to reveal the magnet M5 has adhered to the placemat 10 by magnetic power. Again, placemat 10 has metal plates M1 and M2, as shown in FIG. 1A, concealed under first layer 20, such that the magnets M5 of the tableware items 40, 60, and 80 will magnetically couple the tableware items to the placemat 10. The magnets M5 are of sufficient power to magnetically couple the tableware items 40, 60, and 80 to the placemat 10 through the first layer 20. Therefore, the magnets M5 comprise a magnetic power strong enough to cause an attraction to the metallic members M1 and M2 through the first layer 20 of the placemat 10, such that the tableware items are magnetically coupled to the first layer 20 of the placemat 10 by pinching the first layer 20 between magnets M5 and the metal plates M1 and M2. While the magnets M5 are of sufficient power to couple the tableware items to the placemat 10, it is noted that the magnets M5 are easily removed by the user by lifting the tableware item when the user desires to use or remove the tableware item. The tableware items, however, are magnetically coupled to the placemat 10 with sufficient strength to keep the tableware items in place when acted on by wind forces in an outdoor dining setting. The magnetic attraction of the tableware item to the placemat 10 has been tested in outdoor conditions of winds upwards of approximately 40 mph wherein the tableware system of the present invention was shown to sufficiently magnetically couple the tableware items to the placemat 10, such that the tableware items remained stationary. Thus, the present invention is ideal for use at outdoor picnics, sporting events, tailgates, and other like events. Also, the placemat can be used without a table such as on a blanket or directly on the ground when eating outdoors.

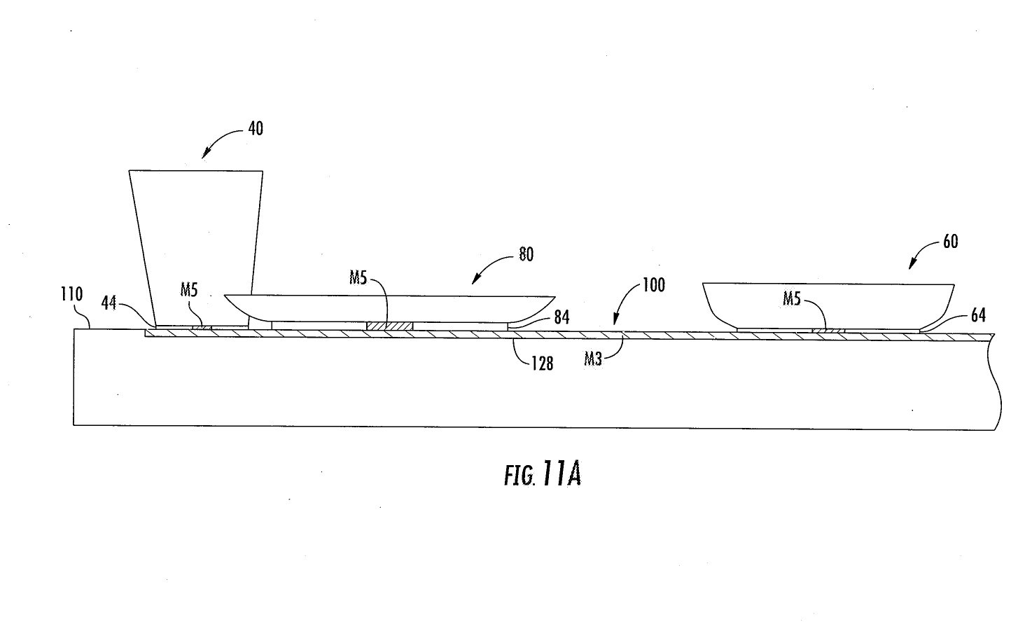

FIG. 11 is a side elevational view of the placemat 10 with the tableware items 40, 60, and 80 as configured in FIG. 10. As shown in FIG. 11, the magnets are concealed within the tableware items and are properly dimensioned within the base portions 44, 64, and 84 of the plurality of tableware items 40, 60, and 80, such that the bottom portions 48, 68, and 88 are substantially flush with the contacting surface of the magnet, such that the tableware items 40, 60, and 80 are flush on the placemat 10. Further, the base portions 44, 64 and 84 of the tableware items 40, 60, 80 are appropriately sized, such that when looking downward on the tableware items 40, 60, 80, the bottom walls of the cavity portions of the tableware items 40, 60, 80 are continuous and do not indicate the location of the magnets affixed to an underside thereto.

This magnet configuration within the base portions 44, 64, and 84 of the tableware items, 40, 60, and 80 is further shown in FIG. 11A, which is the fragmented cross section of a table 100 having a table top 110, having a metallic member M3 further disposed within the recessed area 128. The magnets M5 of the plurality of tableware items 40, 60, and 80 are shown in FIG. 11A as having magnetically coupled the tableware items 40, 60, and 80 to the metallic member M3 disposed in the recess portion 128 of the table top 110. In this configuration, the magnets M5 have sufficient magnetic power to magnetically couple the tableware items 40, 60, and 80 to the metallic member M3, even if the metallic member M3 is powder-coated or painted.

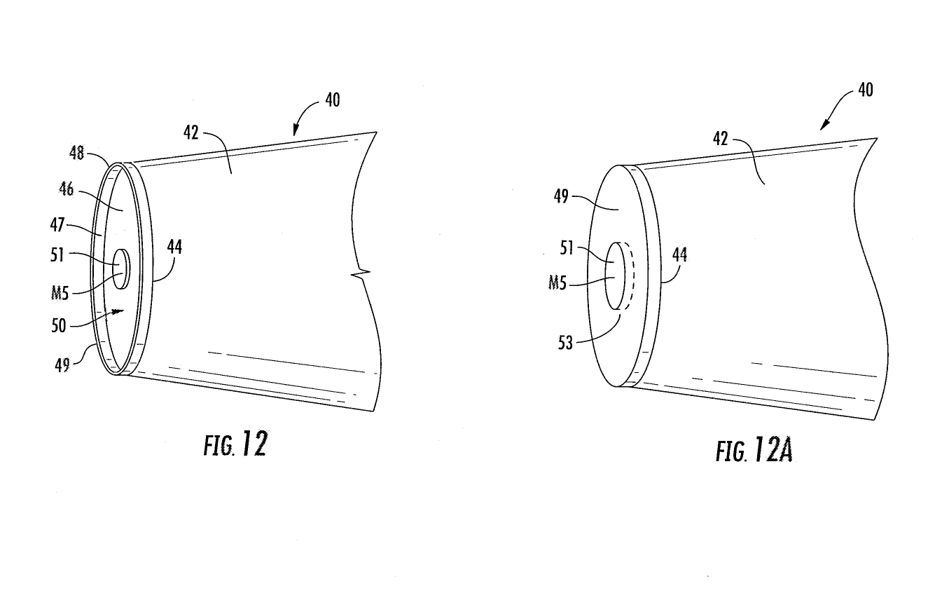

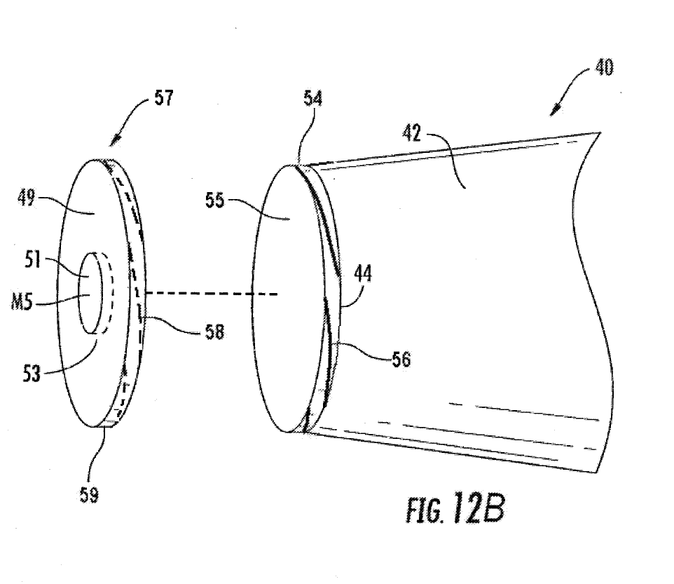

FIG. 12 shows a perspective view of a cup assembly 40 similar to the cup assembly found in FIG. 7A. The base portion 44 of the cup assembly is shown having a top portion or top wall 46 to which a magnet M5 is adhered. The base portion 44 further comprises a bottom portion 48 which has a contacting edge or rim 49 which is used to abuttingly support the cup assembly 40 on a surface. The top portion 46 and bottom portion 48 are spaced apart to provide a recessed area 50 in which the magnet M5 is disposed. The magnet M5 is dimensionally configured to correlate to the dimensions of the recessed area 50, such that the contacting surface 51 of the magnet M5 is substantially flush with the contacting surface or rim 49 of the bottom portion 48 of the base portion 44 of the cup assembly 40, such that the contacting surface 51 of the magnet M5 and the contacting surface 49 of the base portion 44 will both contact a supporting surface when in use to support the cup assembly 40.

FIG. 12A is another embodiment of the cup 40 shown in FIG. 12, wherein the base portion 44 of the cup 40 is a solid member having a bored-out portion 53, as depicted by the dotted lines in FIG. 12A, wherein a magnet M5 is disposed. As shown in FIG. 12A, the bored-out portion 53 of the base portion 44 is dimensionally complimentary to the size of the magnet M5, such that the magnet M5 can be friction-fit within the bored-out cavity 53 or adhered therein using an adhesive. In this configuration, a contacting surface 49 of the base portion 44 is substantially flush with a contacting surface 51 of the magnet M5, thereby providing a continuous contacting surface to support the cup assembly 40 in use.

Referring now to FIG. 12B, a tableware item 40, similar to cup 40 shown in FIG. 12A, can have a detachable base portion 57. In this way, the tableware item 40 has a lower rim or base portion 54 having a bottom surface 55 and threads 56 which are reciprocal threads to a threaded rim portion 59 disposed on the detachable base portion 57. The threaded rim portion 59 of the detachable base portion 57, has threads 58 which matingly or threadedly couple to threads 56 to the lower rim or base portion 54 of the tableware item 40, such that when the detachable base portion 57 of FIG. 12B is coupled to tableware item 40, a configuration similar to the configuration shown in FIG. 12A is realized. Thus, the detachable base portion 57 operable couples to a tableware item, such as tableware item 40, and can further couple to other tableware items in use. In this way, a user of the tableware system of the present invention can have a plurality of detachable bases and use these bases to couple to individual tableware items, such as bowls, cups and dishes, as needed for any given dining situation. While the embodiment shown in FIG. 12B depicts the detachable base portion 57 being operably coupled via a mating thread arrangement with the tableware item 40, it is contemplated that the detachable base portion 57 can couple to the tableware item 40 using any number of known coupling means in the art, including but not limited to a magnetic coupling.

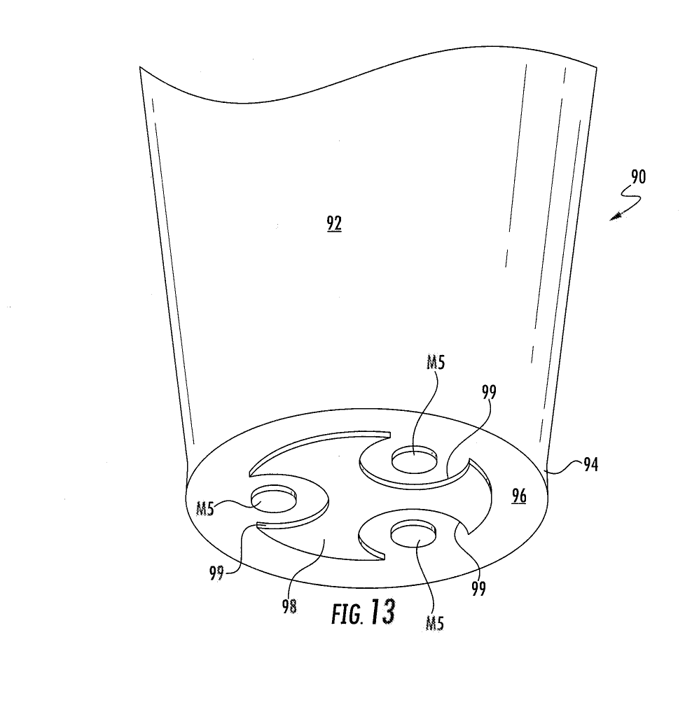

As shown in FIG. 13, another cup item 90 is shown according to embodiments of the present invention wherein the cup 90 has a body portion 92 with a base portion 94 wherein the base portion 94 further comprises a base surface 96 having a buffer portion or standoff portion 98 extending therefrom which acts as a contact surface with a placemat 10 or table 100. As shown in FIG. 13, the standoff portion 98 has cut away portions 99 which house magnets M5 therein. It is contemplated that the buffer portion 98 can have a height as the buffer portion 98 extends off the base surface 96 of the base 94, such that the height of the buffer portion 98 is less than or equal to the height of the magnets M5. In this way, the buffer portion 98 serves as a contact surface to protect the magnets M5 in use. In the embodiment shown in FIG. 13, the cup 90 has three magnets M5 disposed on the base portion 94 thereof, such that the cup 90 is equipped to provide an exceptionally strong magnetic coupling with a placemat 10 or table 100.

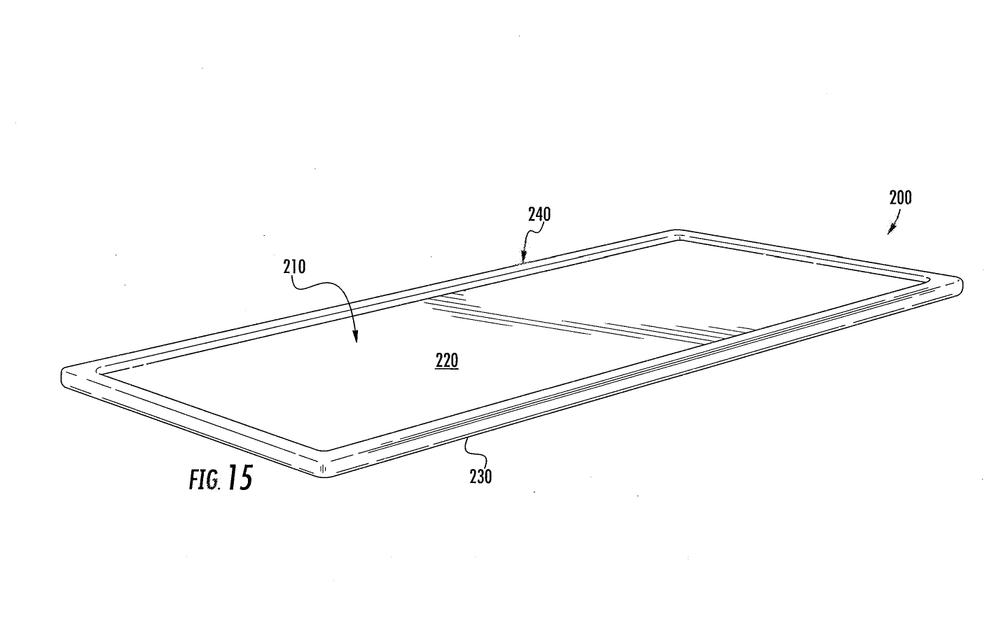

In another embodiment of the present invention, a placemat 200 is shown in FIG. 14. The placemat 200 comprises a hot or cold rolled steel member such as an eighteen (18) gauge steel plate 210 having a first side 220 and a second side 230. As shown in FIGS. 14 and 15, the steel plate 210 comprises a rim portion 240 that can be made of a foam or vinyl material adapted to provide a gripping edge to the placemat 200 as well as protect a user of the placemat 200 from any sharp edges of the metallic plate 210. As shown in FIGS. 14 and 15, the rim portion 240 is disposed about a periphery of the metallic plate 210 thereby covering the entirety of the metallic plate 210 about the peripherally thereof.

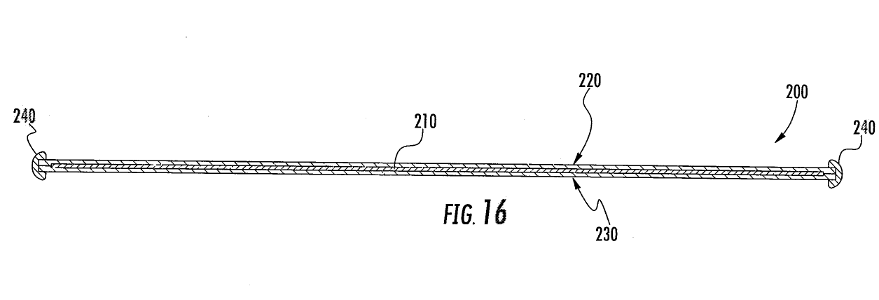

As shown in FIG. 16, the metallic plate 210 can have a powder coating or painted surface, such that the first and second sides 220, 230 comprise a powder coating or painted material to decoratively cover the metallic plate 210 and provide an aesthetically pleasing appearance for the metallic plate 210. It is noted that the placemat 200 as shown and described with reference to FIGS. 14-16, provides a metallic plate for the magnetic coupling of tableware items, such as the tableware items disclosed above with reference to FIGS. 7-13. The placemat 200 as shown in FIGS. 14-16 is a solid unitary member, which is not foldable and thereby provides a heavy metallic plate 210 which can readily sit on a tabletop in a relatively fixed manner provided by the grip of the rim portion 240 and the weight of the metallic plate 210.

Further, it is contemplated that the above-described invention can be used for outdoor dining as well as indoor applications such as magnetic pet dishes and the like. In this way, the present invention can magnetically couple pet dishes to a placemat in a similar fashion as the magnetic coupling of the tableware items to a placemat noted above. This will help to keep the pet dishes in place when pets are eating out of the pet dishes, as pets have a tendency to push unanchored pet dishes around during feeding. Similarly, the present magnetic tableware system can be used to hold children's tableware items in place, so that bowls and dishes are not easily removed by children during feeding.

It is to be understood that variations and modifications can be made on the aforementioned tableware system without departing from the concepts of the present invention and further it is to be understood that such concepts are intended to be covered by the following claims unless these claims, by their language, expressly state otherwise.

The invention claimed is:

1. A tableware system comprising:
a placemat, wherein the placemat comprises a first layer and a second layer;
a metallic member disposed between the first and second layer;
a tableware item having a base portion adapted to engage the placemat; and
a magnet affixed to the base portion of the tableware item having sufficient magnetic power to magnetically couple the tableware item to the placemat through either the first or second layer.

2. The tableware system of claim 1, wherein:
the placemat comprises a first side and a second side;
wherein the placemat further comprises a living hinge disposed between the first side and second side such that the placemat is foldable along the living hinge; and
further wherein a first metallic member is disposed on the first side and a second metallic member is disposed on the second side.

3. The tableware system of claim 1, wherein:
the first layer and second layer comprise a vinyl material.

4. The tableware system of claim 3, wherein:
the vinyl material is a water resistant vinyl material; and
further wherein the first layer and second layer are stitched to one another.

5. The tableware system of claim 1, wherein:
the magnet comprises a Neodymium magnet.

6. The tableware system of claim 1, wherein:
the metallic member comprises a hot rolled or cold rolled steel plate.

7. The tableware system of claim 1, wherein:
the tableware item includes a tableware item selected from the group consisting of bowls, plates and cups.

8. A tableware system comprising:
a table assembly having first and second leg members disposed in a generally spaced apart relationship, and configured to be abuttingly supported on a ground surface in a generally upright orientation;
a top member supported on and operably coupled to the first and second leg members, wherein the top member has at least one recessed area formed thereon;
a metallic member disposed in the at least one recessed area;
a plurality of tableware items having a base portion designed to engage the top member of the table; and
a magnet affixed to the base portion of the tableware item having sufficient magnetic power to magnetically couple the tableware item to the metallic member disposed in the at least one recessed area of the top member.

9. The tableware system of claim 8, wherein:
the table assembly comprises a first side and a second side, wherein the table is foldable along a spacing disposed between the first side and the second side.

10. The tableware system of claim 9, wherein:
the metallic member comprises a hot rolled or cold rolled steel plate.

11. The tableware system of claim 10, wherein:
the magnet comprises a Neodymium magnet.

12. The tableware system of claim 9, wherein:
the first and second leg members are foldable leg members.

13. A tableware system comprising:
a metallic placemat member having a first side, a second side and a periphery;
at least one tableware item having a base portion adapted to engage the placemat in a generally upright orientation; and
a magnet affixed to the base portion of the at least one tableware item having sufficient magnetic power to magnetically couple the tableware item to the metallic placemat member.

14. The tableware system of claim 13, including:
a rim portion disposed about the periphery of the metallic placemat.

15. The tableware system of claim 14, wherein:
the rim portion comprises a foam member adapted to provide a gripping effect to the placemat as placed on a surface.

16. The tableware system of claim 13, wherein:
the metallic placemat comprises a steel plate.

17. The tableware system of claim 13, wherein:
the steel plate is powder coated on the first side and the second side.

18. The tableware system of claim 13, wherein:
the at least one tableware item includes a buffer portion extending from the base portion;
the buffer portion further comprising cutouts adapted to house one or more magnets; and
wherein the one or more magnets have a height associated therewith, and further wherein the buffer portion comprise a height that is equal to or less than the height of the one or more magnets.

19. The tableware system of claim 13, wherein:
the base portion of the at least one tableware item is a detachable base portion operably coupled to the at least one tableware item.
